(19) United States
(12) Patent Application Publication
(10) Pub. No.: US 2017/0150286 A1
(43) Pub. Date: May 25, 2017

(54) APPARATUS AND METHOD FOR COPY-PROTECTED GENERATION AND REPRODUCTION OF A WAVE FIELD SYNTHESIS AUDIO REPRESENTATION

(71) Applicant: Fraunhofer-Gesellschaft zur Foerderung der angewandten Forschung e.V., Munich (DE)

(72) Inventors: Thomas SPORER, Fuerth (DE); René RODIGAST, Tautenhain (DE)

(21) Appl. No.: 15/381,669

(22) Filed: Dec. 16, 2016

Related U.S. Application Data
(63) Continuation of application No. PCT/EP2015/063209, filed on Jun. 12, 2015.

(30) Foreign Application Priority Data
Jun. 20, 2014 (DE) 10 2014 211 899.9

(51) Int. Cl. H04S 3/00; G10L 19/018

(52) U.S. Cl. CPC H04S 3/002; G10L 19/018; H04S 2400/01; H04S 2420/13

(57) ABSTRACT

An embodiment provides an apparatus for generating a copy-protected wave field synthesis audio representation of an audio scene with a plurality of audio objects, wherein each audio object includes an audio file and position information. The apparatus includes a watermark embedder for embedding a watermark in the audio file of at least one of the plurality of audio objects for generating a modified audio file for the at least one audio object, wherein the watermark specifies a reproduction room. Further, the apparatus includes a wave field synthesis processor for generating the copy-protected wave field synthesis audio representation of the audio scene by using a loudspeaker configuration of the specific reproduction room of the modified audio file and the position for the at least one audio object.

### CROSS-REFERENCE TO RELATED APPLICATIONS

This application is a continuation of copending International Application No. PCT/EP2015/063209, filed Jun. 12, 2015, which is incorporated herein by reference in its entirety, and additionally claims priority from German Application No. 10 2014 211 899.9, filed Jun. 20, 2014, which is also incorporated herein by reference in its entirety.

Embodiments of the present invention relate to an apparatus for generating a copy-protected wave field synthesis audio representation of an audio scene, to an associated method as well as to an apparatus for reproducing a copy-protected wave field synthesis audio representation of an audio scene and an associated method. Further embodiments relate to a computer program for performing the methods.

### BACKGROUND OF THE INVENTION

In wave field synthesis reproduction systems, the raw data, i.e., the audio objects typically present as audio file as well as the metadata are stored and transmitted, respectively, and rendered in dependence on the actually existing loudspeakers in the reproduction room and the actually existing loudspeaker configuration, respectively (e.g., an array having more than 30 loudspeakers distributed in space). For this, the metadata typically include position information for the enclosed audio objects. During rendering, in dependence on the position information and in dependence on the existing loudspeaker configuration, the audio files are distributed to the plurality of loudspeaker channels with the aim of virtually positioning the individual audio object in the reproduction room. As a result, typically, an audio file allocated to an audio objection is output via all loudspeaker channels but with different scaling (i.e., with different loudness) and with different delay.

In some situations, the hardware in the reproduction room has to be reduced to a minimum, which makes it necessitated that no renderer (in the following called wave field synthesis processor) but only a player having a loudspeaker array is installed therein. In such an approach it has to be considered that the wave field synthesis audio representation of an audio scene is pre-rendered for the correct loudspeaker configuration and that the correctly pre-rendered wave field synthesis audio representation is played in the correct reproduction room, since reproduction of an audio representation in the wrong room (i.e., with a wrong loudspeaker array) typically results in a significant reduction of the audio quality. For example, based on this concept, an erroneous operation with subsequent quality losses cannot be precluded in cinemas having several rooms and different loudspeaker setups.

Further demands, in particular in the context of pre-rendered content, are made by the rights management, such that measures have to be taken that reproduction of certain content in a reproduction room is only allowed when a license is available. There are several approaches in conventional technology to address this problem.

One solution would be, for example, in particular for the license problem, the usage of encryption and the storage of the key separately, e.g., in a dongle (generally: portable memory medium). Here, the dongle is advantageously designed such that the same is sufficiently difficult to copy. By this procedure, it can be ensured that reproduction is only enabled with the dongle. A disadvantage of this approach is that when the dongle gets lost the entire license content can no longer be played. Additionally, the data rate to be encrypted is relatively high which opposes the aim of reducing the hardware to the most essential.

As an alternative to encrypting the audio file, so-called audio watermarking (in the following called audio watermark) can be used. Here, a signal masked by the useful signal, i.e., an inaudible signal, is impressed on the audio signal. For example, for preventing audible interferences by the watermark, the watermark may only be impressed in individual channels. On the reproduction side, a watermark detector can extract the watermark and deny reproduction when the watermark does not match the identification number of the reproduction system for which the license is available. This watermarking technology is also compatible with the technology of pre-rendering, such that based on a watermark, association of a pre-rendered wave field synthesis audio representation with a specific reproduction room can be determined in advance.

A basic problem in copy protection by audio watermarking is that deliberate destruction by means of try and error is possible. The background is that the “attacker” has access to the watermark and can change the signal until the watermark will no longer be detectable. In particular in the approach stated above, according to which the watermark is only impressed in a single channel, such as a loudspeaker channel of a pre-rendered wave field synthesis audio representation, there is the problem that by comparing the correlation of two adjacent channels a targeted attack is made easier. Thus, there is a need for an improved approach.

### SUMMARY

According to an embodiment, an apparatus for generating a copy-protected wave field synthesis audio representation of an audio scene with a plurality of audio objects, wherein each audio object includes an audio file and position information, may have: a watermark embedder for embedding a watermark in the audio file of at least one of the plurality of audio objects for generating a modified audio file for the at least one audio object, wherein the watermark specifies a specific reproduction room for which the wave field synthesis audio representation is rendered in dependence on a loudspeaker configuration existing in the specific reproduction room; and a wave field synthesis processor for generating the copy-protected wave field synthesis audio representation of the audio scene by using the loudspeaker configuration of the specific reproduction room, the modified audio file and the position information for the at least one audio object.

According to another embodiment, a method for generating a copy-protected wave field synthesis audio representation of an audio scene with a plurality of audio objects, wherein each audio object includes an audio file and position information, may have the steps of: embedding a watermark in the audio file of at least one of the plurality of audio objects for generating a modified audio file for the at least one audio object, wherein the watermark specifies a specific reproduction room for which the wave field synthesis audio representation is rendered in dependence on a loudspeaker configuration existing in the specific reproduction room; and generating the copy-protected wave field synthesis audio representation of the audio scene by using the loudspeaker configuration of the specific reproduction room, the modified audio file and the position information for the at least one audio object.

According to another embodiment, an apparatus for reproducing a copy-protected wave field synthesis audio representation of an audio scene in a specific reproduction room may have: a watermark detector for detecting a watermark specifying the specific reproduction room in several loudspeaker channels of the copy-protected wave field synthesis audio representation of the audio scene, wherein the watermark is distributed across several loudspeaker channels; and a player for playing the copy-protected wave field synthesis audio representation only when the watermark detector has detected the watermark that specifies the specific reproduction room for which the wave field synthesis audio representation is rendered in dependence on a loudspeaker configuration existing in the specific reproduction room in several of the loudspeaker channels.

According to another embodiment, a method for reproducing a copy-protected wave field synthesis audio representation of an audio scene in a specific reproduction room may have the steps of: detecting a watermark specifying the specific reproduction room for which the wave field synthesis audio representation is rendered in dependence on a loudspeaker configuration existing in the specific reproduction room in several loudspeaker channel of the copy-protected wave field synthesis audio representation of the audio scene, wherein the watermark is distributed in several of the loudspeaker channels; and playing the copy-protected wave field synthesis audio representation only when the watermark specifying the specific reproduction room has been detected in several of the loudspeaker channels.

Another embodiment may have a non-transitory digital storage medium having a computer program stored thereon to perform the method for generating a copy-protected wave field synthesis audio representation of an audio scene with a plurality of audio objects, wherein each audio object includes an audio file and position information, the method having the steps of: embedding a watermark in the audio file of at least one of the plurality of audio objects for generating a modified audio file for the at least one audio object, wherein the watermark specifies a specific reproduction room for which the wave field synthesis audio representation is rendered in dependence on a loudspeaker configuration existing in the specific reproduction room; and generating the copy-protected wave field synthesis audio representation of the audio scene by using the loudspeaker configuration of the specific reproduction room, the modified audio file and the position information for the at least one audio object, when said computer program is run by a computer.

Another embodiment may have a non-transitory digital storage medium having a computer program stored thereon to perform the method for reproducing a copy-protected wave field synthesis audio representation of an audio scene in a specific reproduction room, the method having the steps of: detecting a watermark specifying the specific reproduction room for which the wave field synthesis audio representation is rendered in dependence on a loudspeaker configuration existing in the specific reproduction room in several loudspeaker channel of the copy-protected wave field synthesis audio representation of the audio scene, wherein the watermark is distributed in several of the loudspeaker channels; and playing the copy-protected wave field synthesis audio representation only when the watermark specifying the specific reproduction room has been detected in several of the loudspeaker channels, when said computer program is run by a computer.

A first embodiment provides an apparatus for generating a copy-protected wave field synthesis audio representation of an audio scene having a plurality of audio objects, wherein each audio object includes an audio file and position information. The apparatus includes a watermark embedder for embedding a watermark in the audio file of at least one of the plurality of audio objects for generating a modified audio file for the at least one audio object, wherein the watermark specifies a reproduction room. Further, the apparatus includes a wave field synthesis processor for generating the copy-protected wave field synthesis audio representation of the audio scene by using a loudspeaker configuration of the specific reproduction room of the modified audio file and the position for the at least one audio object.

A second aspect of the present invention relates to an allocated method including the steps of embedding the watermark and generating the copy-protected wave field synthesis audio representation.

Thus, these first two aspects of the invention are based on the knowledge that a watermark is inserted in a pre-rendered wave field synthesis audio representation, such that the watermark specifies the reproduction room for which the wave field synthesis audio representation is calculated. According to the invention, the watermark is inserted in the un-rendered audio files (raw data) i.e., in the audio tracks provided prior to rendering, such that the watermark is linked to at least one audio object (and not to a specific loudspeaker channel). Impressing the watermark into the raw data enables that the watermark is distributed across all loudspeaker channels and at least a group of the loudspeaker channels, respectively, after rendering. In particular, compared to conventional technology, this has the advantage that the watermark cannot be easily removed again from the pre-rendered wave field synthesis audio representation. This is also supported by the fact that the watermark varies in time together with its “carrier object” in dependence on the position information for the respective object.

According to a further embodiment, the watermark is embedded into the audio file of the audio object such that the watermark is inaudible, at least from a psychoacoustic point of view, by means of post-masking, pre-masking, simultaneous masking and/or noise masking.

According to an embodiment, the watermark can be embedded into the audio file of the audio object having a specific characteristic, such as into the loudest audio object. Inserting the watermark into the loudest audio object offers the advantage that the psychoacoustic masking is maximized.

Further embodiments provide (according to a third aspect) an apparatus for reproducing a copy-protected wave field synthesis audio representation of an audio scene in a specific reproduction room. The apparatus includes a watermark detector for detecting a watermark specifying the specific reproduction room in at least one loudspeaker channel of the copy-protected wave field synthesis audio representation of the audio scene and a player for playing the copy-protected wave field synthesis audio representation only when the watermark detector has detected the watermark specifying the specific reproduction room.

According to a fourth aspect of the invention, a method for reproducing a copy-protected wave field synthesis audio representation of an audio scene is provided, which includes the steps of detecting the watermark and playing the copy-protected wave synthesis audio representation.

According to an embodiment, the watermark to be detected (i.e., the watermark for the respective room) is stored in the watermark detector or can be read in from a data carrier, e.g., via an interface.

According to a further embodiment, the watermark detector includes a frequency spreader and a correlator that serve to determine a correlation between the watermark to be detected which is transformed into a spectral form by means of the frequency spreader and a signal in the at least one loudspeaker channel.

According to a fifth and sixth aspect of the invention, a computer program is provided by which the steps or substeps of the above described methods can be performed.

### BRIEF DESCRIPTION OF THE DRAWINGS

Embodiments of the present invention will be detailed subsequently referring to the appended drawings, in which:

FIG. 1a is a schematic block diagram of an apparatus for generating a copy-protected wave field synthesis audio representation according to a first embodiment;

FIG. 1b is a schematic flow diagram of a method for generating a copy-protected wave field synthesis audio representation according to a further embodiment;

FIG. 2a is a schematic block diagram of an apparatus for reproducing a copy-protected wave field synthesis audio representation according to a second embodiment;

FIG. 2b is a schematic flow diagram of a method for reproducing a copy-protected wave field synthesis audio representation according to a further embodiment;

FIG. 3 is a schematic block diagram of a wave field synthesis processor for explaining the steps during wave field synthesis rendering; and

FIG. 4 is a schematic block diagram of a watermark embedder for explaining the mode of operation when embedding a watermark in an audio file.

### DETAILED DESCRIPTION OF THE INVENTION

Embodiments of the present invention will be discussed below in detail with reference to the accompanying drawings, wherein it should be noted that the same elements and the elements having the same functions are provided with the same reference numbers such that the description of the same is inter-exchangeable or inter-applicable.

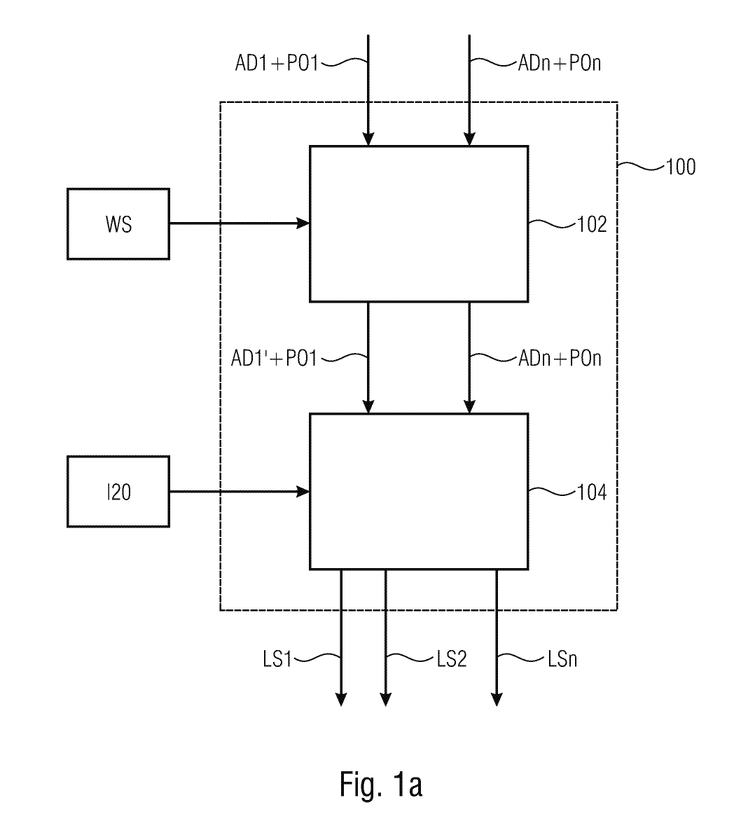

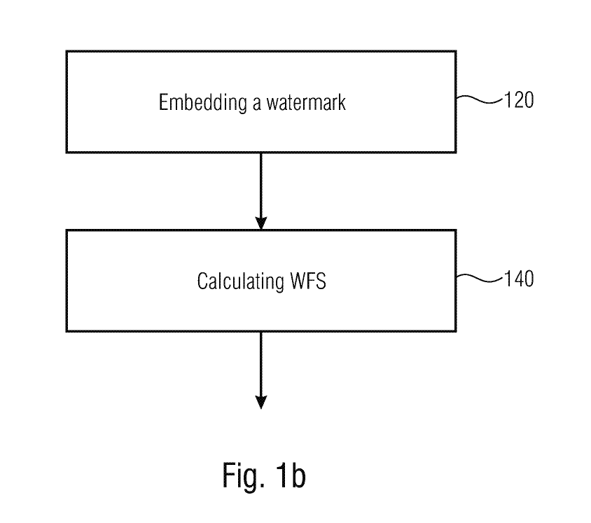

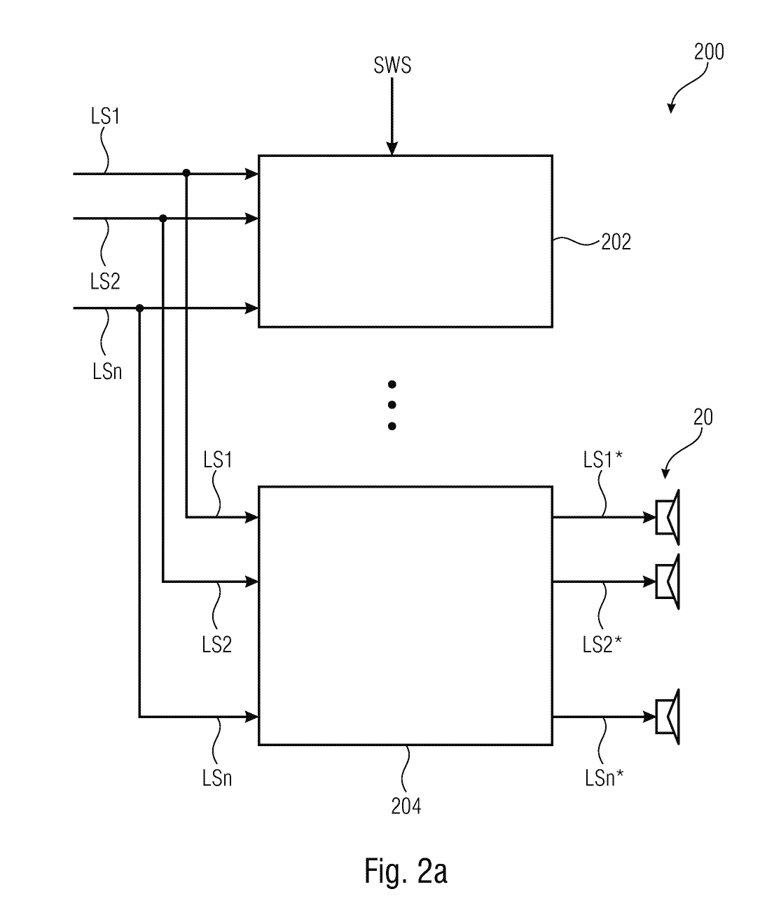

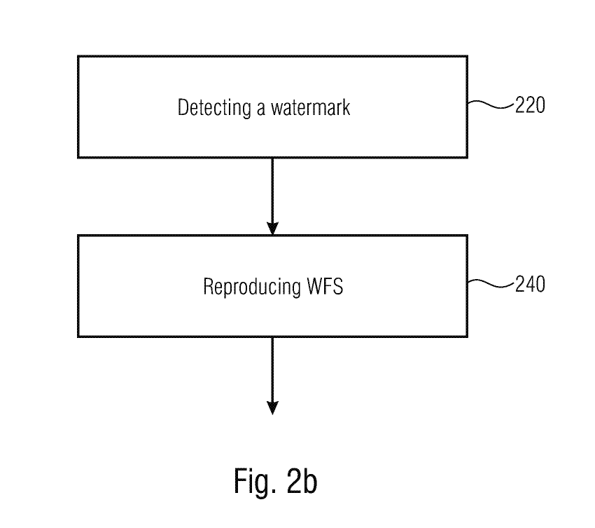

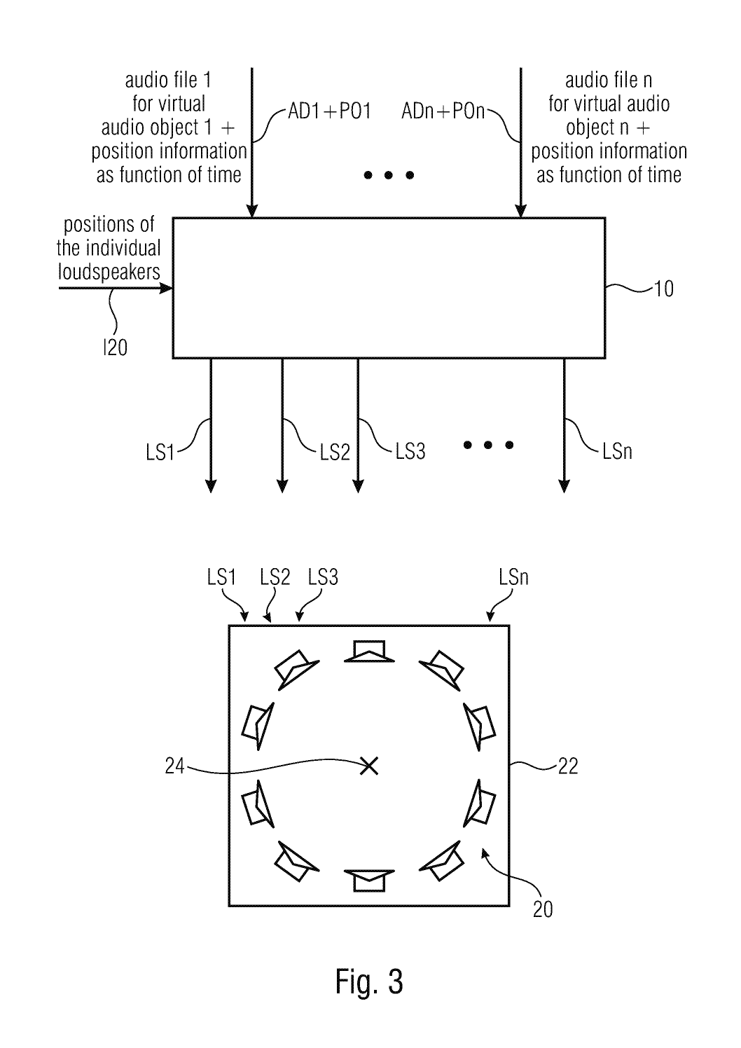

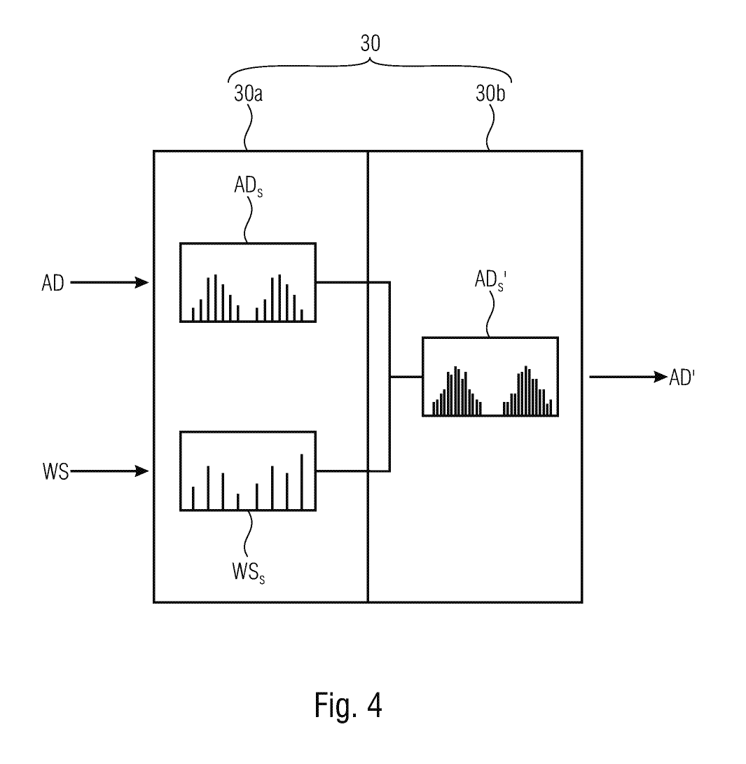

Before the embodiments of the present invention are discussed in detail with reference to FIGS. 1a, 1b, 2a and 2b, a wave field synthesis processor will be explained based on FIG. 3 and a watermark embedder based on FIG. 4.

FIG. 3 shows a wave field synthesis processor 10 together with a schematic loudspeaker array 20.

The loudspeaker array 20 typically includes a plurality of individual loudspeakers controlled via loudspeaker channels LS1-LSn. The loudspeaker array having, for example, 40 or 60 loudspeakers can be implemented, e.g., as 360° array that is arranged in a specific reproduction room 22. The room 22 can, for example, be a cinema auditorium, where the loudspeakers of the loudspeaker array 20 are grouped around the viewer 24 or arranged in an array. Accordingly, the loudspeakers are arranged, for example, behind the screen, behind the viewer as well as to the left and right beside the listener.

Also, at the point P, the listener is surrounded by the plurality of loudspeakers of the loudspeaker array 20, such that an audio object can be positioned virtually in space and can be moved, respectively with respective control of the loudspeaker array 20 by means of the loudspeaker channels LS1 and LSn (e.g., with one-sided control of a subset of the loudspeakers of the loudspeaker array 20). This virtual positioning and virtual movement, respectively, of the one audio object heavily depends on the accurate knowledge of the loudspeaker configuration (cf. loudspeaker array 20), such that the individual loudspeaker channels LS1-LSn can only be determined for a specific loudspeaker array 20 in a specific reproduction room 22. The determination and calculation, respectively, is performed by the wave field synthesis processor 10, as will be discussed below.

The wave field synthesis processor 10 is configured to calculate a plurality of loudspeaker channels LS1-LSn, based on a plurality of audio objects AO1-AOn, each including an audio file and position information (defined as position in a Cartesian coordinate system together with movement information over time), by using an information (120) on the loudspeaker configuration 20 (number and position) of the specific reproduction room 22.

For this, the wave field synthesis processor includes a plurality of inputs (cf. AD1-ADn) via which a plurality of audio signals is supplied for different audio objects. In that way, the input (cf. AD1) receives, e.g., an audio file 1 for a first audio object as well as allocated position information of the same. In a cinema setting, for example, the audio object 1 would, for example, be the voice of an actor moving from the left side along to the right side of the screen or possibly additionally away from the viewer and towards the viewer, respectively. The audio file 1 would then be the actual voice of this actor while the position information is a function of time representing the current position of the first actor in the recording setting at a specific time. On the other hand, the audio file n would be the voice, for example, of a further actor which moves in the same way or differently than the first actor. The current position of the other actor is provided to the wave field synthesis processor 10 by position information synchronized with the audio signal n. In practice, different virtual audio objects exist, depending on the recording setting, wherein the audio file of the respective audio object is supplied to the wave field synthesis processor 10 as individual track.

As illustrated above, the wave field synthesis processor outputs a plurality of loudspeaker channels LS1-LSn, either in directly playable analog form, but advantageously in digital form, which can then be played directly via the loudspeakers of the loudspeaker array 20. The wave field synthesis processor 10 receives the positions of the individual loudspeakers in the reproduction setting (cf. listening room 22 and loudspeaker array 20, respectively), such as in a cinema auditorium, as input information 120.

Further, more information, such as on the room acoustics, can be read in via this information input 120.

Generally, the loudspeaker signal which is allocated, for example, to the loudspeaker channel LS1 will be a superposition of component signals of the virtual audio objects such that the loudspeaker signal for the loudspeaker LS1 includes a first component based on first loudspeaker object 1, a second component based on the audio object 2 as well an n-th component based on the audio object n. The individual component signals are linearly superposed, i.e., added after their calculation in order to reproduce the linear superposition at the ear of the listener who hears, in a real setting, a linear superposition of the sound source he can perceive. Due to this superposition, the first, second and n-th audio object are included in each loudspeaker channel LS1-LSn, wherein the audio file is scaled with different scaling factors and/or delayed with different delay factors per loudspeaker channel LS1 and LSn. Here, it should be noted that the scaling in individual loudspeaker channels LS1-LSn can also be performed down to zero, such that an audio object is no longer audible in a loudspeaker channel.

FIG. 4 shows a watermark embedder 30 for embedding a watermark WS in an audio file AD for generating a modulated audio file AD′.

The watermark embedder 30 reads in both the audio file AD, which exists, for example as PCM signal or as bitstream of time-discrete audio samples, and the watermark WS to be embedded. These two read-in digital signals AD and WS are now transformed in a spectral form, i.e., specifically in audio spectral values ADₛ and watermark spectral values WSₛ, e.g., by means of a frequency spreader (cf. stage 30a). Transforming WS to WSₛ can be performed, for example by multiplying the data signal WS with a noise signal (white noise) or pseudo noise signal. Transforming AD to ADₛ can be directly converted, for example, with the aid of a fast Fourier transformation. Starting from the audio file AD and the spectral form of the audio file ADₛ it is possible to determine a psychoacoustic model indicating, among others, areas for masking (e.g., areas having high overall energy and (temporal) masking thresholds of the audio signal, respectively. Masking thresholds indicate how the audio signal can be changed such that the change is irrelevant for the resulting aural impression.

Different mechanisms, such as temporal masking (post-masking, pre-masking or synchronous masking) but also noise masking (masking noise by a signal or masking a signal by noise) are available. When these masking thresholds and the masking areas of the ADₛ, respectively, are known, which can be used for inserting a data signal in masked form into the AD, a combination of ADₛ and WSₛ is performed in a second stage (cf. reference number 30b). In the step of combining, in detail, the audio signal ADₛ is superposed with a weighted version of the data signal WSₛ, whereby during weighting the determined masking thresholds and the determined masking areas, respectively, are considered. The result of this superposition is the modified audio signal AD′ and ADₛ′ (in the spectral variation). By this procedure it is possible to modify an audio file AD until the same is a carrier for a data signal, such as a watermark WS without any change of the audio reproduction audible for a human being when playing the audio file AD′.

FIG. 1a shows an apparatus 100 for generating a copy-protected wave field synthesis audio representation of an audio scene. The apparatus 100 includes inputs for a plurality of audio objects (cf. AD1+PO1 and ADn+POn, respectively) and outputs for a plurality of loudspeaker channels LS1-LSn. Further, the apparatus 100 includes a watermark embedder 102 and a wave field synthesis processor 104. The watermark embedder 102 is arranged on the input side, i.e., on the sides of the inputs for the audio objects AD1+PO1 and ADn+POn. The wave field synthesis processor 104 is provided on the output side, i.e., on the sides of the outputs for the loudspeaker channels LS1-LSn. Subsequently, the mode of operation of the apparatus 100 will be described with reference to FIG. 1b showing the allocated method.

The wave field synthesis audio representation of the audio scenes is based at least on a plurality of audio objects (cf. AD1+PO1 and ADn+POn, respectively). Each audio object includes thus, as already illustrated above, an audio file AD1 or ADn as well as allocated position information PO1 or POn.

In a first step, the apparatus 100 (cf. FIG. 1b, step 120) embeds the watermark WS, which is available as a digital signal for the watermark embedder 102, in at least one audio file, i.e., either AD1 or ADn of the plurality of audio objects. The watermark specifies a specific reproduction room for which the wave field synthesis audio representation is rendered. Here, the watermark can include an ID or an individual unique ID of the reproduction room, the player in the reproduction room or generally a key allocated to the room. Embedding can be performed according to the above described process. The result of the embedding is at least a modified audio file AD1′ or ADn′ (here AD1′).

Thus, the watermark embedder 102 outputs the modified audio file AD1′ together with the position information PO1 and further forwards the unmodified audio file ADn together with the position information POn. When the watermark embedder 102 embeds the watermark in several audio files AD1 and ADn, according to further embodiments, several modified audio files AD1′ and ADn′ are output together with the position information PO1 and POn. Alternatively, the position information may not be passed on by the watermark embedder 102 but may be supplied directly to the wave field synthesis processor 104.

According to further embodiments, the watermark embedder 102 can also embed the watermark only into one audio file having a specific characteristic. The characteristic can, for example, be a relative volume of an audio object with respect to the other audio objects or a relative activity of an audio object compared to the other objects. Also, the watermark embedder 102 is configured to examine the plurality of audio objects with regard to a characteristic to be detected and to select the same for embedding the watermark.

Even when the watermark embedder 102 has been described as comprising the functionality of the watermark embedder as described in FIG. 4, the same can also be configured differently and can use other embedding mechanisms for watermarks.

The wave field synthesis processor 104 is the second functional element of the apparatus 100 that calculates, starting from the plurality of audio objects ADn+POn, wherein at least one audio object includes a modified audio file AD1′, a wave field synthesis audio representation, i.e., scaling of the individual audio objects AD1′+PO1 and ADn+POn for the respective reproduction room (cf. FIG. 1b, step 140) in order to output the audio objects in scaled, delayed and summed form by means of the individual loudspeaker channels LS1-LSn. For this, the wave field synthesis processor receives, apart from the audio files AD1′/ADn and position information PO1/POn of the audio objects, also information on the loudspeaker configuration I20. The calculation is basically performed as explained above. Accordingly, the audio representation of the audio scene is output as a plurality of loudspeaker channels LS1-LSn and can be stored on a memory medium, such as a hard drive or Blu-ray, wherein the plurality of loudspeaker channels LS1-LSn is advantageously stored separately.

As a result, the watermark (audio watermark) is distributed (statically and temporally) across all or at least several loudspeaker channels LS1-LSn and has the same acoustic position as the individual audio objects. Thereby, from the point of view of psychoacoustics, it is optimally inaudible since the same direction also means the same maximum masking. Further, it can be ensured that the watermark cannot be easily detected and removed, such as by a comparison of individual loudspeaker channels. The background for this is that the watermark is distributed across all or at least a large part of the loudspeaker channels, but with differing scaling and delay, such that no correlation between channels allowing a conclusion on the watermark can be detected.

FIG. 2a shows an apparatus 200 for reproducing a copy-protected wave field synthesis audio representation of the audio scene. The apparatus 200 includes a watermark detector 202 and a player 204. The apparatus 200 includes a data interface for the loudspeaker channels LS1-LSn, which can be accessed both by the watermark detector 202 and the player 204. The player 204 is, on the one hand, informationally connected to the watermark detector 202, and, on the other hand, coupled to the loudspeaker array 20 either directly or via an amplifier for the plurality of loudspeaker channels, here indicated by LS1*-LSn*. In the following, the mode of operation of the apparatus 200 will be discussed together with the allocated method on which the apparatus 200 is based (cf. FIG. 2b).

The wave field synthesis audio representation which can be stored, for example on a mobile date carrier, is read into the apparatus 200 in the form of already rendered loudspeaker channels LS1-LSn, wherein the individual loudspeaker channels LS1-LSn are available for both components 202 and 204 of the apparatus 200.

In a first step (cf. FIG. 2b, step 220), detection of the watermark to be detected SWS, which is either stored in the watermark detector 202 or can be read in from outside is performed. Reading-in the watermark to be detected SWS can be performed, for example, by means of a dongle or generally by means of an external storage medium which is connected to the apparatus 200. The watermark to be detected SWS corresponds to the watermark WS discussed or explained with regard to FIG. 1. For detecting the watermark to be detected SWS, the same is typically rendered in advance, wherein rendering is basically performed analogously to inserting. Thus, the watermark is transformed, i.e., by means of a noise generator (frequency spreader) in a spectral form. This spectral version of the watermark to be detected SWS can then be compared to the loudspeaker channels LS1-LSn by means of a correlator. Advantageously, the watermark detector 202 is configured to detect the watermark to be detected SWS in the plurality of loudspeaker channels LS1-LSn.

According to a further embodiment, the watermark can, when the same is allocated, for example, to the loudest audio object, only be detected in the loudest loudspeaker channel since the loudest loudspeaker channel typically also includes the loudest object. Here, it should be noted that this does not necessarily apply, in particular when several spatially adjacent audio objects are louder than the individually loudest object.

Thus, when the watermark has been determined in a loudspeaker channel or advantageously in several loudspeaker channels by means of correlation, an enable signal can be transmitted to the player 204, which then enables the reproduction of the wave field synthesis audio representation.

As a result, the player 204 reproduces the audio representation (cf. FIG. 2b, step 240), wherein the actual reproduction basically only represents transmission of the loudspeaker signals LS1-LSn, for example in amplified form as loudspeaker signals LS1*-LSn*, to the loudspeaker array 20.

According to a further embodiment, active reproduction prevention by the player 204 based on the watermark detector 202 would be possible. This has the advantage that destroying the watermark in the loudspeaker channels LS1-LSn will still not lead to a success that reproduction of the loudspeaker channels LS1-LSn and the wave field synthesis audio representation, respectively, is performed.

All in all, the above-described concept offers the advantage that no separate renderer is necessitated on the side of the player and hence the computing power can be kept low. By this reduced computing power, the pre-rendered content that is secured by the audio watermark can also be played by less performant platforms, such as embedded boards or DSPs in connection with a data memory. These players can then be used as mobile systems, e.g., in switch boxes, wall boxes, foreign devices or as separate devices.

Although some aspects have been described in the context of an apparatus, it is obvious that these aspects also represent a description of the corresponding method, such that a block or device of an apparatus also corresponds to a respective method step or a feature of a method step. Analogously, aspects described in the context of a method step also represent a description of a corresponding block or detail or feature of a corresponding apparatus. Some or all of the method steps may be executed by (or using) a hardware apparatus, like, for example, a microprocessor, a programmable computer or an electronic circuit. In some embodiments, some or several of the most important method steps may be executed by such an apparatus.

An inventively encoded signal, such as an audio signal or a video signal or a transport stream signal can be stored on a digital memory medium or can be transmitted on a transmission medium, such as a wireless transmission medium or a wired transmission medium, e.g., the Internet.

The inventive encoded audio signal can be stored on a digital memory medium or can be transmitted on a transmission medium, such as a wireless transmission medium or a wired transmission medium, such as the Internet.

Depending on certain implementation requirements, embodiments of the invention can be implemented in hardware or in software. The implementation can be performed using a digital storage medium, for example a floppy disk, a DVD, a Blu-Ray disc, a CD, an ROM, a PROM, an EPROM, an EEPROM or a FLASH memory, a hard drive or another magnetic or optical memory having electronically readable control signals stored thereon, which cooperate or are capable of cooperating with a programmable computer system such that the respective method is performed. Therefore, the digital storage medium may be computer readable.

Some embodiments according to the invention include a data carrier comprising electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer.

The program code may for example be stored on a machine readable carrier.

Other embodiments comprise the computer program for performing one of the methods described herein, wherein the computer program is stored on a machine readable carrier.

In other words, an embodiment of the inventive method is, therefore, a computer program comprising a program code for performing one of the methods described herein, when the computer program runs on a computer.

A further embodiment of the inventive methods is, therefore, a data carrier (or a digital storage medium or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transmit a computer program for performing one of the methods described herein to a receiver. The transmission can be performed electronically or optically. The receiver may, for example, be a computer, a mobile device, a memory device or the like. The apparatus or system may, for example, comprise a file server for transferring the computer program to the receiver.

In some embodiments, a programmable logic device (for example a field programmable gate array, FPGA) may be used to perform some or all of the functionalities of the methods described herein. In some embodiments, a field programmable gate array may cooperate with a microprocessor in order to perform one of the methods described herein. Generally, the methods are performed by any hardware apparatus. This can be a universally applicable hardware, such as a computer processor (CPU) or hardware specific for the method, such as ASIC.

While this invention has been described in terms of several advantageous embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. Apparatus for generating a copy-protected wave field synthesis audio representation of an audio scene with a plurality of audio objects, wherein each audio object comprises an audio file and position information, comprising:
a watermark embedder for embedding a watermark in the audio file of at least one of the plurality of audio objects for generating a modified audio file for the at least one audio object,
wherein the watermark specifies a specific reproduction room for which the wave field synthesis audio representation is rendered in dependence on a loudspeaker configuration existing in the specific reproduction room; and
a wave field synthesis processor for generating the copy-protected wave field synthesis audio representation of the audio scene by using the loudspeaker configuration of the specific reproduction room, the modified audio file and the position information for the at least one audio object.

2. Apparatus according to claim 1, wherein the watermark embedder is configured to embed the watermark comprising a predetermined characteristic in the audio file of the audio object of the plurality of audio objects.

3. Apparatus according to claim 2, wherein the predetermined characteristic comprises the relative loudness of an audio object of the plurality of audio objects with respect to the other audio objects and/or wherein the predetermined characteristic comprises the relative activity of an audio object of the plurality of audio objects with respect to the other audio objects.

4. Apparatus according to claim 1, wherein the wave field synthesis processor is configured to calculate, for generating the copy-protected wave field synthesis audio representation of the audio scene, a plurality of loudspeaker channels, wherein the plurality of loudspeaker channels comprises the plurality of audio files of the audio objects that are scaled with different scaling factors and/or delayed with different delay factors depending on the position information.

5. Apparatus according to claim 4, wherein at least two of the plurality of loudspeaker channels comprise the one modified audio file for the at least one audio object in different scalings and/or in different delays.

6. Apparatus according to claim 4, wherein the plurality of loudspeaker channels comprises at least 40 channels.

7. Apparatus according to claim 1, wherein the watermark embedder is configured to embed the watermark in a frequency spectrum of the audio file.

8. Apparatus according to claim 1, wherein the watermark embedder embeds the watermark in the audio file such that the watermark is masked by means of post-masking, pre-masking, simultaneous masking and/or noise masking.

9. Method for generating a copy-protected wave field synthesis audio representation of an audio scene with a plurality of audio objects, wherein each audio object comprises an audio file and position information, comprising:
embedding a watermark in the audio file of at least one of the plurality of audio objects for generating a modified audio file for the at least one audio object,
wherein the watermark specifies a specific reproduction room for which the wave field synthesis audio representation is rendered in dependence on a loudspeaker configuration existing in the specific reproduction room; and
generating the copy-protected wave field synthesis audio representation of the audio scene by using the loudspeaker configuration of the specific reproduction room, the modified audio file and the position information for the at least one audio object.

10. Apparatus for reproducing a copy-protected wave field synthesis audio representation of an audio scene in a specific reproduction room, comprising:
a watermark detector for detecting a watermark specifying the specific reproduction room in several loudspeaker channels of the copy-protected wave field synthesis audio representation of the audio scene, wherein the watermark is distributed across several loudspeaker channels; and
a player for playing the copy-protected wave field synthesis audio representation only when the watermark detector has detected the watermark that specifies the specific reproduction room for which the wave field synthesis audio representation is rendered in dependence on a loudspeaker configuration existing in the specific reproduction room in several of the loudspeaker channels.

11. Apparatus according to claim 10, wherein the player does not play the copy-protected wave field synthesis audio representation when the watermark detector has not detected a watermark that matches the watermark to be detected.

12. Apparatus according to claim 10, wherein the watermark to be detected is stored in the watermark detector or wherein the apparatus comprises an interface via which a portable data carrier in which the watermark to be detected is stored can be connected.

13. Apparatus according to claim 10, wherein the watermark detector comprises a frequency spreader and a correlator that is configured to determine a correlation between the watermark to be detected which has been transformed into a spectral form by means of the frequency spreader and a signal in the several loudspeaker channels.

14. Apparatus according to claim 10, wherein the player is connected to a loudspeaker array in the specific reproduction room which comprises a plurality of loudspeakers, wherein each loudspeaker is controlled with a separate loudspeaker channel of the wave field synthesis audio representation of the audio scene.

15. Method for reproducing a copy-protected wave field synthesis audio representation of an audio scene in a specific reproduction room, comprising:
detecting a watermark specifying the specific reproduction room for which the wave field synthesis audio representation is rendered in dependence on a loudspeaker configuration existing in the specific reproduction room in several loudspeaker channel of the copy-protected wave field synthesis audio representation of the audio scene, wherein the watermark is distributed in several of the loudspeaker channels; and
playing the copy-protected wave field synthesis audio representation only when the watermark specifying the specific reproduction room has been detected in several of the loudspeaker channels.

16. A non-transitory digital storage medium having a computer program stored thereon to perform the method for generating a copy-protected wave field synthesis audio representation of an audio scene with a plurality of audio objects, wherein each audio object comprises an audio file and position information, the method comprising:
embedding a watermark in the audio file of at least one of the plurality of audio objects for generating a modified audio file for the at least one audio object,
wherein the watermark specifies a specific reproduction room for which the wave field synthesis audio representation is rendered in dependence on a loudspeaker configuration existing in the specific reproduction room; and
generating the copy-protected wave field synthesis audio representation of the audio scene by using the loudspeaker configuration of the specific reproduction room, the modified audio file and the position information for the at least one audio object,
when said computer program is run by a computer.

17. A non-transitory digital storage medium having a computer program stored thereon to perform the method for reproducing a copy-protected wave field synthesis audio representation of an audio scene in a specific reproduction room, the method comprising:
detecting a watermark specifying the specific reproduction room for which the wave field synthesis audio representation is rendered in dependence on a loudspeaker configuration existing in the specific reproduction room in several loudspeaker channel of the copy-protected wave field synthesis audio representation of the audio scene, wherein the watermark is distributed in several of the loudspeaker channels; and
playing the copy-protected wave field synthesis audio representation only when the watermark specifying the specific reproduction room has been detected in several of the loudspeaker channels,
when said computer program is run by a computer.
